(19) United States
(12) Patent Application Publication
(10) Pub. No.: US 2024/0372379 A1
(43) Pub. Date: Nov. 7, 2024

(54) CELL BALANCING METHOD AND BATTERY SYSTEM PROVIDING THE SAME

(71) Applicant: LG ENERGY SOLUTION, LTD., Seoul (KR)

(72) Inventor: Hyeonju SHIN, Daejeon (KR)

(73) Assignee: LG ENERGY SOLUTION, LTD., Seoul (KR)

(21) Appl. No.: 18/685,108

(22) PCT Filed: Oct. 7, 2022
(86) PCT No.: PCT/KR2022/015106

§ 371 Date: Feb. 20, 2024

(30) Foreign Application Priority Data
Dec. 3, 2021 (KR) 10-2021-0171884

(51) Int. Cl. H02J 7/00; H01M 10/42; H01M 10/44

(52) U.S. Cl. CPC H02J 7/0014; H01M 10/441; H02J 7/0048; H02J 7/007182; H01M 2010/4271

(57) ABSTRACT

The present invention relates to a cell balancing method and a battery system providing the method. The battery system according to one example of the present invention includes: a battery including a plurality of battery cells; a cell monitoring integrated circuit (IC) that measures a cell voltage of each of the plurality of battery cells; a current sensor that measures a battery current flowing in the battery; and a main control circuit that estimates a cell state of charge (SOC) of each of the plurality of battery cells based on the cell voltage and the battery current, extracts a minimum cell SOC among cell SOCs of the plurality of battery cells, determines a balancing reference value corresponding to the minimum cell SOC, and determines a need for cell balancing for each of the plurality of battery cells based on the balancing reference value.

### CROSS-REFERENCE TO RELATED APPLICATION(S)

This application claims priority to and the benefit of Korean Patent Application No. 10-2021-0171884 filed in the Korean Intellectual Property Office on Dec. 3, 2021, the entire contents of which are incorporated herein by reference.

### TECHNICAL FIELD

The present invention relates to a cell balancing method for performing customized cell-balancing according to a cell state of charge (SOC) and a battery system providing the same.

### BACKGROUND ART

An electric vehicle (EV) and a hybrid vehicle (HV) use a battery pack as an energy supply source for driving a motor. In this case, the battery pack may include a plurality of battery cells connected in series and/or in parallel.

When the battery pack is used for a long period of time, aging and internal resistance values of each of the plurality of battery cells may vary, and cell deviation may occur among the plurality of battery cells. In this case, the cell deviation may indicate a deviation in a cell state of charge (SOC) and a deviation in a cell voltage. As the cell deviation increases, overcharging or overdischarging may occur so that there is a problem in which a capacity of an entire battery pack is reduced and lifespan of the battery pack is shortened.

To solve this problem, a battery system performs cell balancing to reduce the cell deviation. The battery system may calculate a cell balancing current value based on an open circuit voltage (OCV) value, and may perform the cell balancing for a balancing time calculated based on the cell balancing current value.

On the other hand, a change width of the cell voltage may be different according to the cell state of charge (SOC). For example, in a case of a battery cell having a very small cell SOC or a very large cell SOC, a change in a cell voltage value according to a change in the cell SOC may be large. That is, in a process of performing the cell balancing, a cell voltage of the battery cell having the large (or small) cell SOC may be significantly lowered and a balancing current value of the battery cell having the large (or small) cell SOC may also be lowered. Then, the battery cell having the large (or small) cell SOC may not perform sufficient cell balancing for a preset balancing time.

### DISCLOSURE

### Technical Problem

The present invention is to provide a cell balancing method and a battery system providing the method that reduce cell deviation by performing optimal cell balancing according to a cell state of charge (SOC) of a battery cell.

### Technical Solution

A battery system according to one aspect of the present invention includes: a battery including a plurality of battery cells; a cell monitoring integrated circuit (IC) measuring a cell voltage of each of the plurality of battery cells; a current sensor that measures a battery current flowing in the battery; and a main control circuit that estimates a cell state of charge (SOC) of each of the plurality of battery cells based on the cell voltage and the battery current, extracts a minimum cell SOC among cell SOCs of the plurality of battery cells, determines a balancing reference value corresponding to the minimum cell SOC, and determines a need for cell balancing for each of the plurality of battery cells based on the balancing reference value.

The main control circuit may classify an entire section of the cell SOC into a plurality of SOC sections according to a predetermined criterion, may set a section reference value, which is a start condition of the cell balancing of each of the plurality of SOC sections, according to a predetermined criterion, may select an SOC section to which the minimum cell SOC belongs among the plurality of SOC sections, and may determine the section reference value corresponding to the selected SOC section as the balancing reference value.

The main control circuit may classify the entire section of the cell SOC into the plurality of SOC sections based on a point at which a ratio of the cell voltage to the cell SOC is changed, and may set the section reference value based on the ratio.

The main control circuit may calculate a difference value between the cell SOC of each of the plurality of battery cells and the minimum cell SOC, and may determine that the cell balancing is required for the battery cell exceeding the balancing reference value.

The battery system may further include a cell balancing circuit that includes a plurality of switches and a plurality of resistors, the cell balancing circuit performs the cell balancing of the battery cell exceeding the balancing reference value by controlling a switching operation according to a switching signal among at least one switching signal supplied from the cell monitoring IC. The cell monitoring IC may discharge the battery cell determined as a cell balancing target among the plurality of battery cells through the cell balancing circuit according to a cell balancing control signal transmitted from the main control circuit.

The main control circuit may calculate a balancing time based on a cell SOC of the battery cell determined as the cell balancing target, calculate a difference value between the cell SOC of the battery cell and the minimum cell SOC, and calculate a value of a cell voltage of the battery cell, and may transmit the cell balancing control signal including information on the balancing time to the cell monitoring IC.

A cell balancing method according to another aspect of the present invention includes: determining a balancing reference value based on a minimum cell state of charge (SOC) among cell SOCs of a plurality of battery cells; calculating a difference value between the cell SOC of each of the plurality of battery cells and the minimum cell SOC and comparing the difference value with the balancing reference value to determine a need for cell balancing for each of the plurality of battery cells; and performing the cell balancing on a battery cell determined as a cell balancing target when the cell balancing is required for at least one battery cell.

The determining of the balancing reference value may include: estimating the cell SOC of each of the plurality of battery cells based on a cell voltage of each of the plurality of battery cells; extracting the minimum cell SOC among the cell SOCs of the plurality of battery cells; selecting an SOC section to which the minimum cell SOC belongs among a plurality of SOC sections configured by classifying an entire section of the cell SOC according to a predetermined criterion; and determining a section reference value corresponding to the selected SOC section as the balancing reference value.

The plurality of SOC sections may be configured by classifying the entire section of the cell SOC based on a point at which a ratio of the cell voltage to the cell SOC is changed, and the section reference value may be set based on the ratio of the cell voltage to the cell SOC corresponding to the plurality of SOC sections.

The performing of the cell balancing may include: calculating a balancing time based on a cell SOC of the battery cell determined as the cell balancing target, calculating a difference value between the cell SOC of the battery cell and the minimum cell SOC, calculating a value of a cell voltage of the battery cell, and performing the cell balancing of the battery cell during the balancing time.

The determining of the need for the cell balancing may include determining the battery cell exceeding the balancing reference value as the cell balancing target.

### Advantageous Effects

The present invention may determine a need for cell balancing according to a reference value corresponding to a cell charge of charge (SOC) to increase accuracy of the cell balancing.

### DESCRIPTION OF THE DRAWINGS

FIG. 1 is a view illustrating a battery system for providing a cell balancing method according to an embodiment.

FIG. 2 is an example diagram of a graph for explaining a reference value determined corresponding to a cell state of charge (SOC) according to an embodiment.

FIG. 3 is a flowchart illustrating a cell balancing method according to an embodiment.

FIG. 4 is a flowchart for describing in detail a step of determining a balancing reference value of FIG. 3.

### MODE FOR INVENTION

Hereinafter, embodiments disclosed in the present specification will be described in detail with reference to the accompanying drawings, and in the present specification, the same or similar constituent elements will be denoted by the same or similar reference numerals, and a redundant description thereof will be omitted. The terms “module” and/or “unit, portion, or part” representing constituent element used in the following description are used only in order to make understanding of the specification easier, and thus, these terms do not have meanings or roles that distinguish them from each other by themselves. In addition, in describing embodiments of the present specification, when it is determined that a detailed description of the well-known art associated with the present invention may obscure the gist of the present invention, it will be omitted. Further, the accompanying drawings are provided only in order to allow embodiments disclosed in the present specification to be easily understood and are not to be interpreted as limiting the spirit disclosed in the present specification, and it is to be understood that the present invention includes all modifications, equivalents, and substitutions without departing from the scope and spirit of the present invention.

Terms including ordinal numbers such as first, second, and the like will be used only to describe various constituent elements, and are not to be interpreted as limiting these constituent elements. The terms are only used to differentiate one constituent element from other constituent elements.

It is to be understood that when one constituent element is referred to as being “connected” or “coupled” to another constituent element, it may be connected or coupled directly to the other constituent element or may be connected or coupled to the other constituent element with a further constituent element intervening therebetween. In contrast, it should be understood that, when it is described that an element is “directly coupled” or “directly connected” to another element, no element is present between the element and the other element.

In the present application, it should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance.

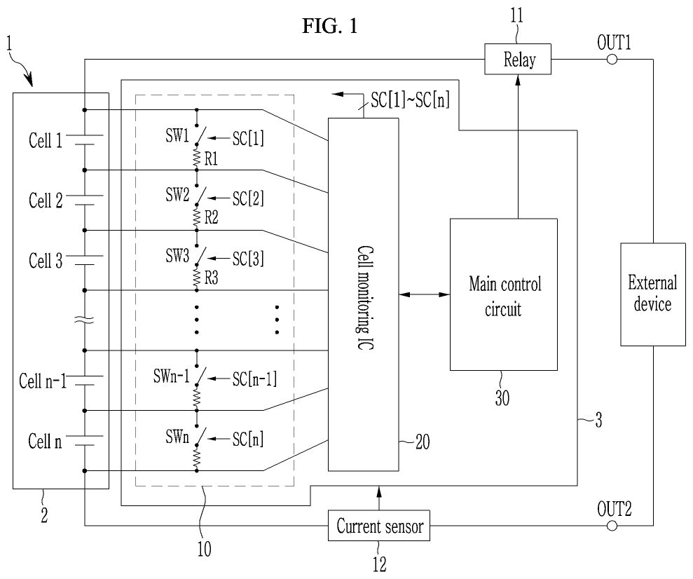

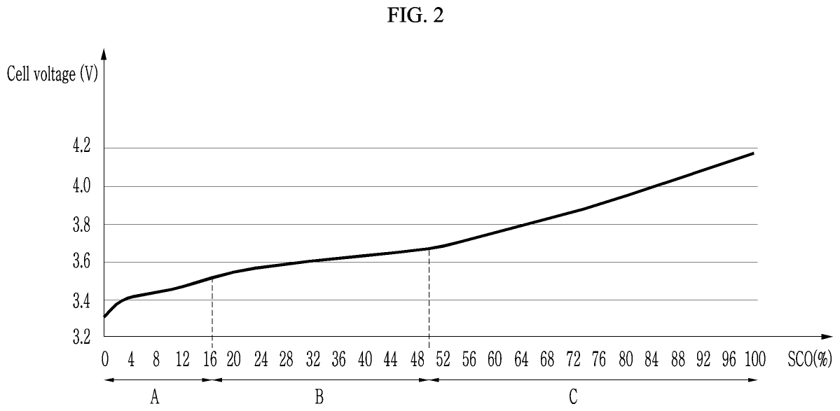

FIG. 1 is a view illustrating a battery system providing a cell balancing method according to an embodiment, and FIG. 2 is an example diagram of a graph for explaining a reference value determined corresponding to a cell state of charge (SOC) according to an embodiment.

As shown in FIG. 1, the battery system 1 includes a battery 2, a BMS (a battery management system) 3, a relay 11, and a current sensor 12.

The battery 2 may include a plurality of battery cells connected in series/parallel to supply necessary power to an external device. In FIG. 1, the battery 2 includes a plurality of battery cells Cell1-Celln connected in series, and is connected between two output terminals OUT1 and OUT2 of the battery system 1. In addition, the relay 11 is connected between a positive electrode of the battery system 1 and the output terminal OUT1, and a current sensor 12 is connected between a negative electrode of the battery system 1 and the output terminal OUT2. Configurations shown in FIG. 1 and a connection relationship between the configurations are embodiments, but the present invention is not limited thereto.

The relay 11 controls electrical connection between the battery system 1 and the external device. When the relay 11 is turned on, the battery system 1 and the external device are electrically connected so that charging or discharging is performed. When the relay 11 is turned off, the battery system 1 and the external device are electrically separated. The external device may be a load or a charger.

The current sensor 12 is connected in series to a current path between the battery 2 and the external device. The current sensor 12 may measure a current (that is, a charging current and a discharging current) flowing in the battery 2, and may transmit the measurement result to the BMS 3.

The BMS 3 includes a cell balancing circuit 10, a cell monitoring IC (or a cell monitoring integrated circuit) 20, and a main control circuit 30.

The cell balancing circuit 10 includes a plurality of switches SW1-SWn and a plurality of resistors R1-Rn. Each of the plurality of switches SW1-SWn performs a switching operation according to a corresponding switching signal among a plurality of switching signals SC[1]-SC[n] supplied from the cell monitoring IC 20. For each of the plurality of battery cells Cell1-Celln, a corresponding switch SWi and a corresponding resistor Ri are connected in series between a positive electrode and a negative electrode of a corresponding cell Celli. When the switch SWi is turned on, a discharging path is formed between the corresponding cell Celli, the switch SWi, and the resistor Ri, and the corresponding cell Celli discharges. In this case, i is one of natural numbers from 1 to n.

The cell monitoring IC 20 is electrically connected to a positive electrode and a negative electrode of each of the plurality of battery cells Cell1-Celln to measure a cell voltage of each of the plurality of battery cells. A value of a current (hereinafter referred to as a battery current) measured by the current sensor 12 may be transmitted to the cell monitoring IC 20. The cell monitoring IC 20 transfers information on the measured cell voltage and battery current to the main control circuit 30. Specifically, the cell monitoring IC 20 measures the cell voltage of each of the plurality of battery cells Cell1-Celln every predetermined period during a rest period in which charging and discharging does not occur, and transfers the measured result to the main control circuit 30.

The cell monitoring IC 20 may discharge a cell to be balanced among the plurality of battery cells Cell1-Celln through the cell balancing circuit 10 according to a cell balancing control signal transmitted from the main control circuit 30. For example, the cell monitoring IC 20 may generate the plurality of switching signals SC[1]-SC[n] according to the cell balancing control signal of the main control circuit 30. Each of the switching signals SC[1]-SC[n] may control a switching operation of the corresponding switch SWi. When an on-level switching signal SC[i] is supplied to the corresponding switch SWi, the switch SWi is turned on so that the corresponding cell Celli is discharged.

The main control circuit 30 determines a balancing reference value based on a minimum cell state of charge (SOC) (min SOC) among the cell state of charge (SOC) (Csoc) of each of the plurality of battery cells Cell1-Celln. In this case, the balancing reference value may be a reference value for determining a target of cell balancing among the plurality of battery cells Cell1-Celln.

The main control circuit 30 may classify an entire section of the cell SOC (Csoc) into a plurality of SOC sections according to a predetermined criterion, and may set a section reference value, which is a start condition for cell balancing of each of the plurality of SOC sections, according to a predetermined criterion. In addition, the main control circuit 30 may select an SOC section to which the minimum cell state of charge (SOC) (min SOC) belongs among the plurality of SOC sections, and may determine the section reference value corresponding to the selected SOC section as the balancing reference value.

Referring to FIG. 2, the main control circuit 30 may divide the entire section of the cell SOC from 0% to 100% into a plurality of SOC sections A, B, and C according to a predetermined criterion. For example, in FIG. 2, the main control circuit 30 may divide the entire cell section of the cell SOC (0% to 100%) into a first SOC section (0% or more and less than 16%), a second SOC section (16% or more and less than 51%), and a third SOC section (51% or more and 100% or less) according to a slope value of a SOC-voltage correlation graph (hereinafter referred to as S-VCG). The S-VCG is a graph in which a cell voltage value corresponding to the cell SOC (Csoc) is shown.

According to an embodiment, the main control circuit 30 may divide the entire section of the cell SOC into the plurality of SOC sections A, B, and C based on a point at which a ratio of the cell voltage to the cell SOC (Csoc) is changed. The point at which the ratio of the cell voltage to the cell SOC (Csoc) is changed may be a point at which the slope value is changed in the S-VCG.

In FIG. 2, a slope of the graph is changed based on a value of the cell SOC (Csoc) of about 16%, and the slope of the graph is changed again based on about 51%. Specifically, in the first SOC section (0% or more and less than 16%) and the third SOC section (51% or more and 100% or less), a cell voltage change amount (i.e., the slope of the graph) is large, and when the second SOC section (16% or more and less than 51%) is compared with the first SOC section and the third SOC section, the cell voltage change amount (i.e., the slope of the graph) is small in the second SOC section.

The section reference value may be a condition for determining a battery cell requiring cell balancing or the start condition (or a reference value) for performing the cell balancing. That is, the section reference value may be a condition for determining whether the cell balancing of the battery cell is required in each of the plurality of SOC sections. The balancing reference value may be the section reference value corresponding to a selected SOC section among the plurality of SOC sections.

For example, in FIG. 2, the section reference value of each of the first SOC section A and the third SOC section C may be 1.5%, and the section reference value of the second SOC section B may be 3%. In addition, when the second SOC section B is selected according to a method to be described below, the section reference value (3%) of the second SOC section B may be determined as the balancing reference value.

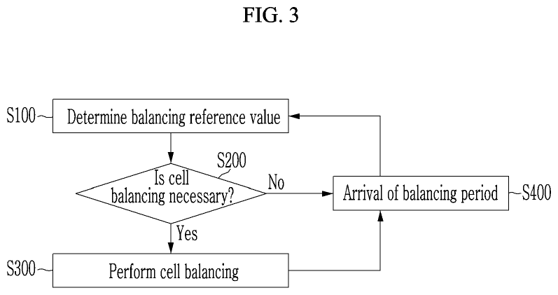

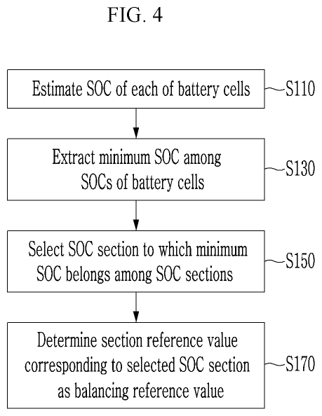

The main control circuit 30 may determine a need for cell balancing for each of the plurality of battery cells Cell1-Celln according to the method to be described below, and if at least one battery cell (hereinafter referred to as a cell balancing target) requiring the cell balancing exists as a result of the determination, the cell balancing may be performed. A more detailed description will be described in detail with FIGS. 3 and 4 below.

FIG. 3 is a flowchart illustrating a cell balancing method according to an example embodiment, and FIG. 4 is a flowchart for describing in detail a step S100 of determining a balancing reference value of FIG. 3.

Hereinafter, the cell balancing method and the battery system providing the method will be described with reference to FIGS. 1 to 4.

Referring to FIG. 3, first, the main control circuit 30 determines the balancing reference value that is the start condition for cell balancing (S100).

The balancing reference value may be the start condition (or a reference value) for determining whether the cell balancing is required for each of the plurality of battery cells Cell1-Celln. According to an embodiment, the main control circuit 30 may determine the balancing reference value corresponding to the cell SOCs (Csoc) of the plurality of battery cells Cell1-Celln rather than a fixed balancing reference value.

Referring to FIGS. 3 and 4, in the step S100, the main control circuit 30 estimates the cell SOC (or the SOC) for each of the plurality of battery cells Cell1-Celln based on at least one of the cell voltage and the battery current every balancing period (S110).

The balancing period may be a predetermined time as a period for performing the cell balancing, but the present disclosure is not limited thereto. The balancing period may include the rest period in which the battery 2 is not charged or discharged. For example, the main control circuit 30 may estimate the cell SOC (hereinafter referred to as Csoc) of each of the plurality of battery cells Cell1-Celln using various known methods for each predetermined balancing period or for each rest period.

In the step S100, the main control circuit 30 extracts the minimum cell SOC (min SOC) among the SOCs (Csoc) for the plurality of battery cells Cell1-Celln (S130).

In the step S100, the main control circuit 30 selects the SOC section to which the minimum cell SOC (min SOC) belongs among the plurality of SOC sections configured by classifying the entire section of the cell SOC according to the predetermined criterion (S150).

In the step S100, the main control circuit 30 determines the section reference value corresponding to the selected SOC section as the balancing reference value (S170).

For example, it is assumed that the battery 2 includes first to fourth battery cells Cell1-Cell4 and first to fourth cell SOCs (C_{soc_1}, C_{soc_2}, C_{soc_3}, and C_{soc_4}) of the first to fourth battery cells Cell1-Cell4 are respectively 26%, 29%, 30%, and 31%. In addition, in FIG. 2, it is assumed that the section reference value of each of the first SOC section A and the third SOC section C is 1.5% and the section reference value of the second SOC section B is 3%. The main control circuit 30 extracts the first cell SOC (C_{soc_1}), which is a minimum value among the first to fourth cell SOCs (C_{soc_1}, C_{soc_2}, C_{soc_3}, and C_{soc_4}), as the minimum cell SOC (min SOC). Referring to FIG. 2, the main control circuit 30 selects the second SOC section B to which a value (26%) of the first cell SOC (C_{soc_1}) belongs among the first to third SOC sections A, B, and C. The main control circuit 30 may determine the section reference value (3%) corresponding to the second SOC section B as the balancing reference value.

Next, the main control circuit 30 determines a need of the cell balancing for each of the plurality of battery cells Cell1-Celln (S200).

The main control circuit 30 calculates a difference value between the cell SOC of each of the plurality of battery cells Cell1-Celln and the minimum cell SOC (min SOC). The main control circuit 30 may determine a battery cell having the difference value exceeding the balancing reference value as the cell balancing target.

For example, when the first to fourth cell SOCs (C_{soc_1}, C_{soc_2}, C_{soc_3}, C_{soc_4}) are 26%, 29%, 30%, and 31%, difference values between the cell SOCs of the plurality of battery cells Cell1-Celln and the minimum cell SOC are 0%, 3%, 4%, and 5%. The main control circuit 30 may determine the second to fourth battery cells Cell2-Cell4 whose the difference values exceed the balancing reference value (3%) as cell balancing targets. In this case, the balancing reference value (3%) is the balancing reference value determined in the step S100.

Next, if the cell balancing is required as a result of the determination (Yes in S200), the main control circuit 30 performs the cell balancing on a battery cell determined as the cell balancing target (S300).

In the step S300, the main control circuit 30 calculates a balancing time (T_{B}) based on a cell SOC of the battery cell determined as the cell balancing target, a difference value between the cell SOC of the battery cell and the minimum cell SOC, and a value of a cell voltage of the battery cell.

The balancing time (T_{B}) is a time required to perform the cell balancing of the battery cell. The balancing time (T_{B}) may be calculated by the following Equation 1 and Equation 2. For example, the main control circuit 30 may calculate a value of a balancing current (I_{B}) according to the following Equation 1, and may calculate the balancing time (T_{B}) according to the following Equation 2.

$${I}_{B} - \frac{{V}_{C}}{{R}_{B}} \qquad [ Equation 1 ]$$

According to Equation 1, the main control circuit 30 may calculate a value of the balancing current (I_{B}) based on a value of the cell voltage (V_{C}) and a value of a balancing resistor R_{B}. Referring to FIG. 1, the cell voltage (V_{C}) may correspond to the cell voltage of each of the plurality of battery cells Cell1-Celln, and the balancing resistor R_{B} may correspond to each of the plurality of resistors R1-Rn. That is, when the values of the cell voltage of each of the plurality of battery cells Cell1-Celln are different each other, the value of the balancing current (I_{B}) of each of the plurality of battery cells may also be different.

$${T}_{B} = \frac{{C}_{SOC} \times 100}{{I}_{B}} \times {D}_{SOC} \qquad [ Equation 2 ]$$

According to Equation 2, the main control circuit 30 may calculate the balancing time (T_{B}) based on the value of the cell SOC (Csoc), the value of the balancing current (I_{B}), and an SOC reduction amount (Dsoc). The cell SOC (Csoc) may correspond to the cell SOC of each of the plurality of battery cells Cell1-Celln. The value of the balancing current (I_{B}) may be the value of the balancing current (I_{B}) calculated by the above Equation 1. The SOC reduction amount (Dsoc) may be the difference value between the cell SOC of each of the plurality of battery cells Cell1-Celln and the minimum cell SOC (min SOC). That is, the capacity reduction amount (Dsoc) may correspond to a SOC value discharged from the battery cell during a cell balancing process.

In the step S300, the main control circuit 30 transmits the cell balancing control signal including information on the balancing time (T_{B}) to the cell monitoring IC 20 so that the main control circuit controls the cell monitoring IC to perform the cell balancing on the battery cell determined as the cell balancing target.

For example, when the second to fourth battery cells Cell2-Cell4 are determined as the cell balancing target as discussed above, the main control circuit 30 may calculate the balancing time (T_{B}) of each of the second to fourth battery cells. The main control circuit 30 may control the cell monitoring IC 20 to perform the cell balancing according to the balancing time (T_{B}) corresponding to each of the second to fourth battery cells Cell2-Cell4.

The cell monitoring IC 20 may discharge the battery cell determined as the cell balancing target among the plurality of battery cells Cell1-Celln through the cell balancing circuit 10 according to the cell balancing control signal transmitted from the main control circuit 30 so that the cell monitoring IC performs the cell balancing.

Next, if the cell balancing is not required as a result of the determination (No in S200) or if the cell balancing is terminated, the main control circuit 30 counts a next balancing period. The main control circuit 30 may repeat the method from the step S100 when the balancing period arrives (S400).

According to an embodiment, the main control circuit 30 may newly determine the balancing reference value whenever whether to perform the cell balancing is determined. For example, the main control circuit 30 may determine the balancing reference value for each predetermined period or for each rest period (for example, a period in which charging and discharging is not performed) of the battery 2, and may determine whether to perform the cell balancing based on the determined balancing reference value.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

1. A battery system comprising:
a battery including a plurality of battery cells;
a cell monitoring integrated circuit (IC) that measures a cell voltage of each of the plurality of battery cells;
a current sensor that measures a battery current flowing in the battery; and
a main control circuit that estimates a cell state of charge (SOC) of each of the plurality of battery cells based on the cell voltage and the battery current, extracts a minimum cell SOC among cell SOCs of the plurality of battery cells, determines a balancing reference value corresponding to the minimum cell SOC, and determines a need for cell balancing for each of the plurality of battery cells based on the balancing reference value.

2. The battery system of claim 1, wherein the main control circuit classifies an entire section of the cell SOC into a plurality of SOC sections according to a predetermined criterion, sets a section reference value, which is a start condition of the cell balancing of each of the plurality of SOC sections, according to a predetermined criterion, selects a SOC section to which the minimum cell SOC belongs among the plurality of SOC sections, and determines the section reference value corresponding to the selected SOC section as the balancing reference value.

3. The battery system of claim 2, wherein the main control circuit classifies the entire section of the cell SOC into the plurality of SOC sections based on a point at which a ratio of the cell voltage to the cell SOC is changed, and sets the section reference value based on the ratio.

4. The battery system of claim 3, wherein the main control circuit calculates a difference value between the cell SOC of each of the plurality of battery cells and the minimum cell SOC, and determines that the cell balancing is required for the battery cell exceeding the balancing reference value.

5. The battery system of claim 4, further comprising a cell balancing circuit that includes a plurality of switches and a plurality of resistors,
wherein the cell balancing circuit performs the cell balancing of the battery cell exceeding the balancing reference value by controlling a switching operation according to a switching signal among at least one switching signal supplied from the cell monitoring IC, and
wherein the cell monitoring IC discharges the battery cell determined as a cell balancing target among the plurality of battery cells through the cell balancing circuit according to a cell balancing control signal transmitted from the main control circuit.

6. The battery system of claim 5, wherein the main control circuit:
calculates a balancing time based on a cell SOC of the battery cell determined as the cell balancing target,
calculates a difference value between the cell SOC of the battery cell and the minimum cell SOC, and
calculates a value of a cell voltage of the battery cell, and transmits the cell balancing control signal including information on the balancing time to the cell monitoring IC.

7. A cell balancing method comprising:
determining a balancing reference value based on a minimum cell state of charge (SOC) among cell SOCs of a plurality of battery cells;
calculating a difference value between the cell SOC of each of the plurality of battery cells and the minimum cell SOC and comparing the difference value with the balancing reference value to determine a need for cell balancing for each of the plurality of battery cells; and
performing the cell balancing on a battery cell determined as a cell balancing target when the cell balancing is required for at least one battery cell.

8. The cell balancing method of claim 7, wherein the determining of the balancing reference value comprises:
estimating the cell SOC of each of the plurality of battery cells based on a cell voltage of each of the plurality of battery cells;
extracting the minimum cell SOC among the cell SOCs of the plurality of battery cells;
selecting an SOC section to which the minimum cell SOC belongs among a plurality of SOC sections configured by classifying an entire section of the cell SOC according to a predetermined criterion; and
determining a section reference value corresponding to the selected SOC section as the balancing reference value.

9. The cell balancing method of claim 8, wherein the plurality of SOC sections are configured by classifying the entire section of the cell SOC based on a point at which a ratio of the cell voltage to the cell SOC is changed, and the section reference value is set based on the ratio of the cell voltage to the cell SOC corresponding to the plurality of SOC sections.

10. The cell balancing method of claim 9, wherein the performing of the cell balancing comprises:
calculating a balancing time based on a cell SOC of the battery cell determined as the cell balancing target;
calculating a difference value between the cell SOC of the battery cell and the minimum cell SOC;
calculating a value of a cell voltage of the battery cell; and
performing the cell balancing of the battery cell during the balancing time.

11. The cell balancing method of claim 9, wherein the determining of the need for the cell balancing comprises determining the battery cell exceeding the balancing reference value as the cell balancing target.
